(19) United States
(12) Patent Application Publication
(10) Pub. No.: US 2016/0364460 A1
(43) Pub. Date: Dec. 15, 2016

(54) METHODS OF AGGREGATING AND COLLABORATING SEARCH RESULTS

(71) Applicants: Gary SHUSTER, Fresno, CA (US); Brian SHUSTER, Vancouver (CA); David GOLDSMITH, Manlius, NY (US)

(72) Inventors: Gary SHUSTER, Fresno, CA (US); Brian SHUSTER, Vancouver (CA); David GOLDSMITH, Manlius, NY (US)

(21) Appl. No.: 15/181,359

(22) Filed: Jun. 13, 2016

Related U.S. Application Data
(60) Provisional application No. 62/174,441, filed on Jun. 11, 2015.

(51) Int. Cl. G06F 17/30; G06F 3/0484; G06F 3/0488

(52) U.S. Cl. CPC G06F 17/30554; G06F 17/30401; G06F 17/30867; G06F 3/0488; G06F 3/04842

(57) ABSTRACT

Methods of aggregating and collaborating Internet searches, search pathways and components, and performing collaborative searches are disclosed. Data from a plurality of related Internet searches may be aggregated and analyzed to identify common content, pathways and search criteria to determine intent. Subsequent searches by the same or other persons for similar groupings of searches may be directed to the results output from the initial searches. The output from searches may be displayed in a dynamic results page, a word cloud, or other two-dimensional or three-dimensional formats in which users may change the weighting of certain search results, or link words in the results page. Collaborate searches may be performed, wherein a person may simultaneously see searches performed by other persons. Thus, the present invention advantageously displays search results that are particularly appropriate and relevant in much less time than individual searches would take to perform.

### CROSS-REFERENCE TO RELATED APPLICATIONS

This application claims the benefit of U.S. Provisional Patent Application No. 62/174,441 filed Jun. 11, 2015. The text and contents of this provisional patent application is hereby incorporated into this application by reference as if fully set forth herein.

### FIELD OF THE INVENTION

The present invention generally relates to the field of Internet searches. More specifically, embodiments of the present invention pertain to methods of aggregating and collaborating searches to determine the intent of the person searching so as to arrive at relevant search results in a less time-consuming manner.

DISCUSSION OF THE BACKGROUND

The origin of predictive Internet searches may be traced back to 2004, when Google® launched Google Suggest™, later renamed to Google Instant™. Such predictive searches generate search results almost instantly, as a user types. These predictive searches use a predictive search algorithm to predict a user's search query as it is typed, thereby saving users significant time by the user not having to type their full search query.

However, presently, there is no known search method or algorithm that aggregates a plurality of searches performed by a user in order to determine the user's intent in performing multiple searches. By determining a person's intent when performing a plurality of searches, search results may be displayed to subsequent users with the same or similar intent, to significantly increase the speed and reduce the time for performing such subsequent searches.

Additionally, there is presently no known method or algorithm that performs collaborative searches (where a person can simultaneously see what other persons are searching, and how they are searching to arrive at particular results), likewise, to significantly reduce the time to perform such searches, and increase the accuracy and relevancy of the search results.

Further, search results are currently displayed in a linear fashion, which require users to review the results of individual searches separately. There is no known display of search results, which aggregates the results of a plurality of searches, and allows users to change the importance and/or weighting of the aggregated display quickly and easily.

Therefore, it is desirable to provide methods of performing collaborative Internet searches and/or aggregating search results so as to reduce search time and provide relevant results displayed in dynamic manner, whereby searchers may change the weighing of results.

### SUMMARY OF THE INVENTION

The present invention advantageously provides methods of aggregating and collaborating Internet searches, search pathways and/or components, and/or performing collaborative searches in order to minimize the time to perform future searches and maximize the accuracy and/or relevancy of the search results.

In an embodiment of the present invention, data from a plurality of related Internet searches by a person is aggregated and analyzed so as to identify common content, pathways, search criteria, etc., in order to determine the person's intent. Thereafter, subsequent searches by the same and/or other persons searching for the same or a similar grouping of related Internet searches may be directed to the results output from the initial search, thereby displaying results that are particularly appropriate and/or relevant in much less time than separate individual searches would take to perform. In some embodiments, search criteria may be compared to recent news events and/or coordinated with other concurrent and/or recent searches to aggregate and prioritize data and results to increase relevance of the data displayed.

In other embodiments of the present invention, the output results may be displayed in a dynamic results page (e.g., in a word cloud or other format), which, in some aspects, may be user controlled, wherein users may change the weighting given to certain search results and/or select and/or alternate between different types of displays. In some instances, a user/searcher may connect and/or link words in the dynamic results page by touching a touch pad or by clicking with a mouse to create new search terms and/or results.

In another aspect, predictive or final results may be displayed in a word cloud or other two-dimensional or three-dimensional format. Using a word cloud as an example, the results may be segregated in areas of the cloud based on differences in the general direction of the search. For example, a search may be entered starting with the first four letters “pres” (see e.g., 601 of FIG. 6). As shown in FIG. 6, Predictive results may include “presidential polls”, “press democrat”, “presidents of the united states”, “pressure washers”, “president Obama”, and “Prescott az” 602. Rather than display them in a traditional manner as illustrated in FIG. 5, the results may instead by displayed in a manner depicted in FIG. 6.

In yet further aspects, collaborative searches may be performed, wherein a person may simultaneously see what other persons are searching, what terms are being used to search, and how other persons are searching to arrive at particular results. Results for such collaborative searches may be displayed in one or more dynamic result pages and users may also change the weighting given to certain search results and/or select and/or alternate between different displays of collaborative results.

In some aspects, additional content and/or results of concurrent and/or subsequent user searches may be added to the dynamic search page results so as to account for information and/or data that may have been missed by an initial or concurrent user. In some instances, a plurality of word clouds may be grouped together in one dynamic display. Users/searchers may select one or more clouds from the group of clouds, and such selected clouds would each be displayed on its own dynamic results page.

A more complete understanding of methods of aggregating and collaborating search results will be afforded to those skilled in the art, as well as a realization of additional advantages and objectives thereof, by consideration of the following detailed description of preferred embodiments. Reference will be made to an appended drawing sheet, which will first be described briefly.

### BRIEF DESCRIPTION OF THE DRAWINGS

FIG. 1 is a list displaying the suggested predictive search terms resulting from a Google® search of the words “school makes me.”

FIG. 2 is graphical representation of a word cloud displaying the suggested predictive search terms of FIG. 1, according to an embodiment of the present invention.

FIG. 3 is a graphical representation of initial search results included in the word cloud of FIG. 2, according to an embodiment of the present invention.

FIG. 4 is a graphical representation of a dynamic results page in a word cloud format, according to an embodiment of the present invention.

FIG. 5 is a computing device with a graphical representation of a display of predictive search results.

FIG. 6 is a list displaying the suggested predictive search terms resulting from a Yahoo® search query after typing the four letters “pres”.

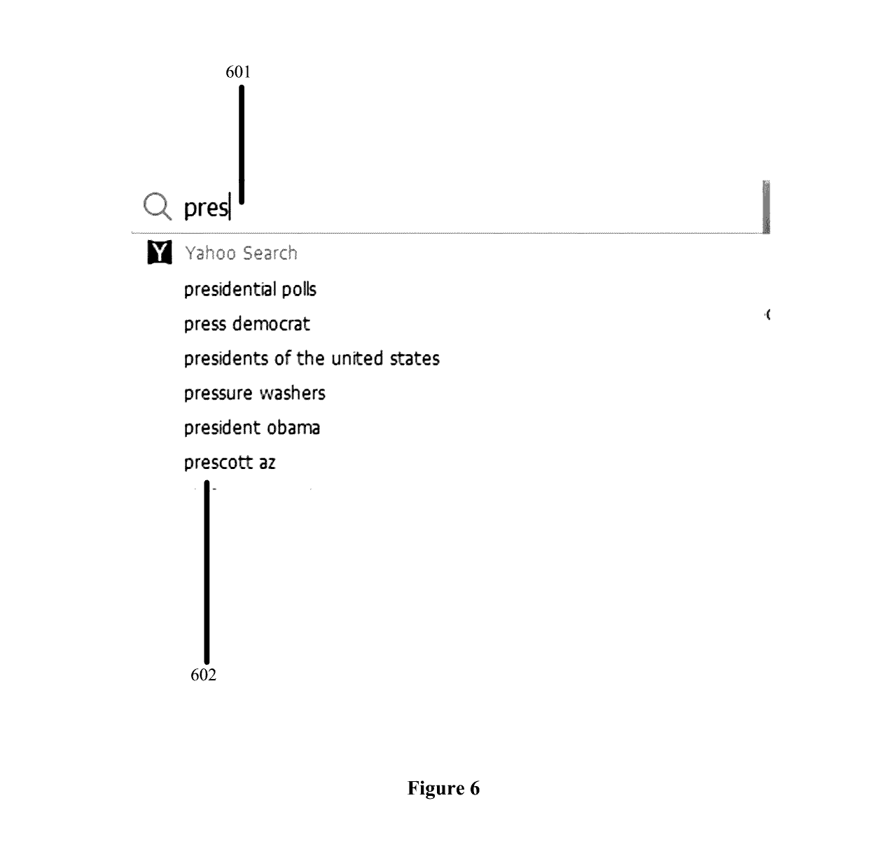

FIG. 7 is a computing device with a graphical representation of a display of predictive search results for the search terms “presidents of the united states” according to an embodiment of the present invention.

FIG. 8 is a computing device with a graphical representation of a display of predictive search results for the search terms “president regan” according to an embodiment of the present invention.

FIG. 9 is a graphical representation of the predictive results for the search term “school” displayed in clusters of word clouds, according to an embodiment of the present invention.

FIG. 10 is a graphical representation of the predictive results of FIG. 9, narrowed by the selection of the cluster containing the words “high, middle, pre, elementary.”

### DETAILED DESCRIPTION OF THE PREFERRED EMBODIMENTS

Reference will now be made in detail to the preferred embodiments of the invention, an example of which is illustrated in the accompanying drawing. While the invention will be described in conjunction with the preferred embodiments, it will be understood that they are not intended to limit the invention to these embodiments. On the contrary, the invention is intended to cover alternatives, modifications, and equivalents that may be included within the spirit and scope of the invention. Furthermore, in the following detailed description of the present invention, numerous specific details are set forth in order to provide a thorough understanding of the present invention. However, it will readily be apparent to one skilled in the art that the present invention may be practiced without these specific details. These conventions are intended to make this document more easily understood by those practicing or improving on the inventions, and it should be appreciated that the level of detail provided should not be interpreted as an indication as to whether such instances, methods, procedures or components are known in the art, novel, or obvious.

Embodiments of the present invention advantageously provide methods of aggregating searches, search pathways, and/or search components, coordinating searches with current events and/or news events, displaying search results in a dynamic format, and performing collaborative searches in order to minimize the time taken to provide search results and maximize the accuracy and relevancy of the results.

In an embodiment, the instant invention aggregates data from a plurality of related Internet searches by a person, analyzes the data to identify common content, threads, pathways, search criteria, etc., so as to determine the person's intent. For example, if a person searches for (1) San Francisco half marathon, (2) hotels in San Francisco, (3) restaurants in San Francisco, (4) airline flights to San Francisco, and (5) taxicab companies in San Francisco, embodiments of the present invention may determine the intent of the person searching to be that he or she is planning to run a half marathon in San Francisco, and needs to travel to and use certain services in San Francisco. Thereafter, subsequent users/persons searching for the same or a similar grouping of related Internet searches may be directed to the results output from the initial persons' search, thereby displaying results that are particularly appropriate and/or relevant in much less time than separate individual searches would take to perform.

Data regarding the history of how the person conducted each of the grouped searches (e.g., search terms, search pathways, trees, search results, click-through to links within the search results, etc.) are collected in order to aid in determining intent and expedite future searches by the same or other persons. In some embodiments, the history that may be traced contains research pathways wherein search inputs are equal to search outputs. In other embodiments, the history may contain research pathways wherein the search inputs exceed the search outputs.

In some embodiments, searches may be grouped and/or aggregated by the time period in which the search is performed. For example, if a person searches for (1) San Francisco half marathon, (2) hotels in San Francisco, (3) restaurants in San Francisco, (4) airline flights to San Francisco, and (5) taxicab companies in San Francisco, all within time period X (e.g., a 2 hour period of time), the searches may be aggregated and/or grouped, and intent of the person determined by the aggregate of the searches. In other aspects, searches may be aggregated and/or grouped based on one or more time periods included in the search. For example, if the San Francisco half marathon occurs on Jul. 26, 2015, and a search by the same person of airline flights is for flights spanning a period of time that includes Jul. 26, 2015, and likewise, a search for hotels in San Francisco similarly spans a period of time that includes Jul. 26, 2015, these searches may be aggregated and used to determine the intent of the person searching.

In other aspects, searches may be aggregated by category and/or contents of search. For example, searches related to a particular location, regardless of whether the search falls outside of time period X or whether the searches include a common time period within the search may be aggregated.

In some embodiments, search criteria may be compared to recent news events and/or coordinated with other concurrent and/or recent searches to aggregate and prioritize data and results to increase relevance of the data displayed. For example, if news that a popular entertainer will appear on a certain date, at a certain location is announced, and a person conducting searches includes the certain date and/or certain location, search results may be displayed that are relevant to the entertainer's appearance (e.g., the price of tickets, cost of airline flights, hotels located in the vicinity, etc.) may be displayed. Similarly, if a large national firm announces it will be hiring a number of employees in a particular location for certain job position and/or with particular work experience, and a person searchers for job opportunities for the same or similar position, work experience and/or location, contact and inquiry information about the national firm's positions may be displayed.

Subsequent users may be displayed the results of previously aggregated and/or grouped searches, when a predetermined threshold number N of the same or related searches are performed by the subsequent user. The search results may then be used by anyone searching in the future for N components of the search pathway. When identifying the same or related searches by subsequent users, the order in which the initial searches were performed, and the order in which the subsequent user's searches are preformed may be compared, but the order is generally not determinative of whether the subsequent user is searching the same and/or related grouping of searches.

The output results of the aggregated searches may be displayed on a dynamic results page. Such dynamic results page may present data in a word cloud and/or other representation (e.g., flow chart, pictograph, stem and leaf plot, etc.) In some aspects, the user may control the format of the data displayed on the dynamic results page, and may select and/or alternate between different types of displays.

In embodiments wherein the data in a dynamic results page is displayed in a word cloud format, some results may be displayed in larger and/or different colored font based on the emphasis and/or weighting of the result. In some aspects, word clouds may be generated using predictive algorithms. In other aspects, word clouds may be created by voice to text translations of search terms and/or aggregating posts of friends on social networking sites.

Whether in conjunction with predictive search, in conjunction with a display of search results, or in conjunction with other search implementations, a word cloud may be displayed. Such word cloud may contain the user's search terms, search terms used in conjunction with similar searches, words analogous to search terms, and/or words from one or more predicted or projected search results. These words may, in one aspect, be grouped with other similar terms, or by subject matter associated with the results.

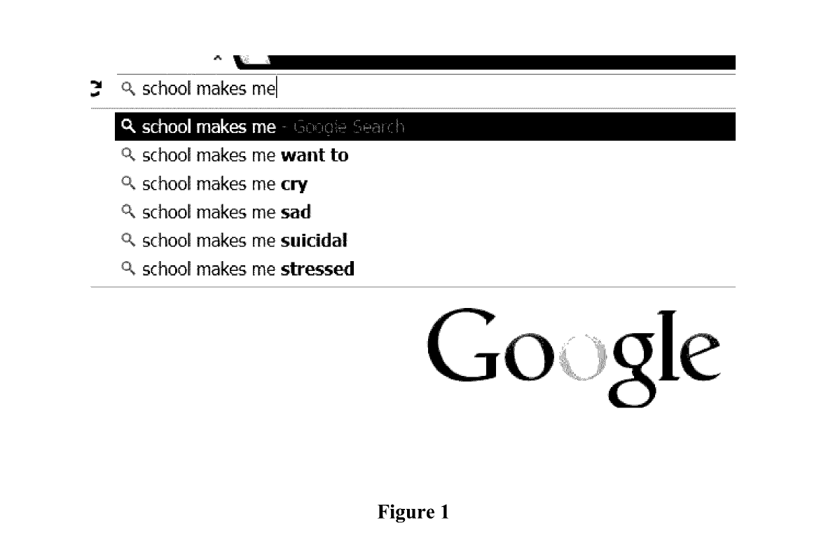

In one aspect, the word cloud would reflect, whether precisely or roughly, the search terms that the system is utilizing to drive the search. For example, if a user typed “school makes me” into Google®, the suggested predictive search terms displayed may be as displayed in FIG. 1.

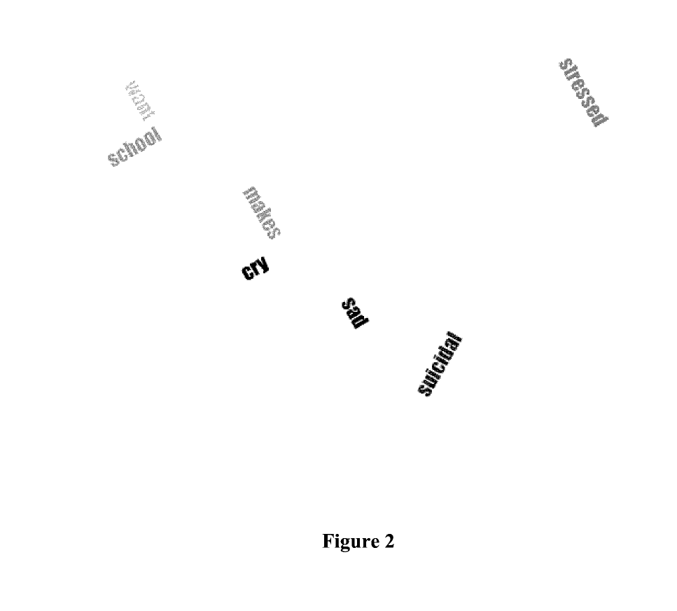

Each of these terms may be presented as part of a word cloud. The user can then utilize touch or other input technology to resize and/or rearrange terms within the cloud. For example, FIG. 2 illustrates an embodiment of how the cloud may appear.

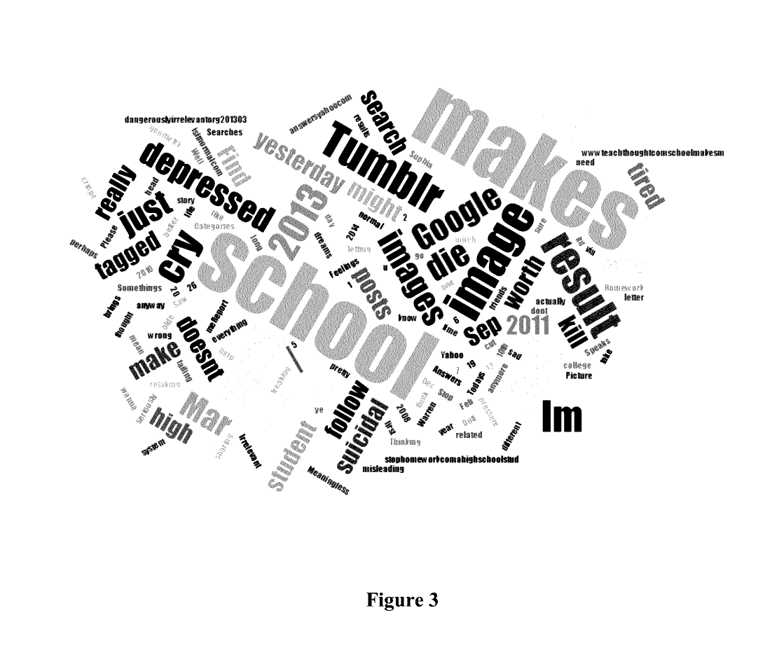

If the initial search results are included in the cloud, the cloud may look similar to FIG. 3.

If the user wants to add weight to the term school, but does not want results related to being “depressed”, “suicidal” or “die”, the user might pinch the latter three terms to make them smaller or disappear, and stretch the term “school” to make that word more important. As the word cloud components change size, their relative weights in generating search results also change.

In one aspect, shrinking or enlarging one term will also change the weight given to synonymous terms. Such change may also be reflected in a change to the appearance of the word cloud. The weight given to certain terms may also be added or subtracted by moving elements of the word cloud closer or further from a point on the display device.

In another aspect, there may be a triggering event that causes a new search to be done to gather new words for the word cloud. Such triggering event could be a change to the size of one of the words in the cloud, passage of time, passage of time since the change to the size of one of the words in the word cloud, passing a “refresh” or similar button, shaking a device, or otherwise providing input to the device indicating that the search generating the word cloud should be refreshed.

In one aspect, the number of terms within a cloud may be limited. Such limitation may be set programmatically, algorithmically, and/or manually.

Separate clouds may also be utilized, each representing a different focus. For example, a search for “race” may result in separate groupings of results, including those referencing “race” as synonymous with “racial”, “race” as synonymous with “a contest of speed”, or “race” as synonymous with “rushing”. A plurality of word clouds may be presented, each generated based on a different meaning of the search term. Where, as with “contest of speed” and “rushing”, more than one synonym may be relevant to results, the user may shrink or close an irrelevant word cloud (such as the cloud associated with “racial”) and/or may adjust the weight given to other word cloud (such as by shrinking the “rushing” cloud and growing the “contest of speed” cloud).

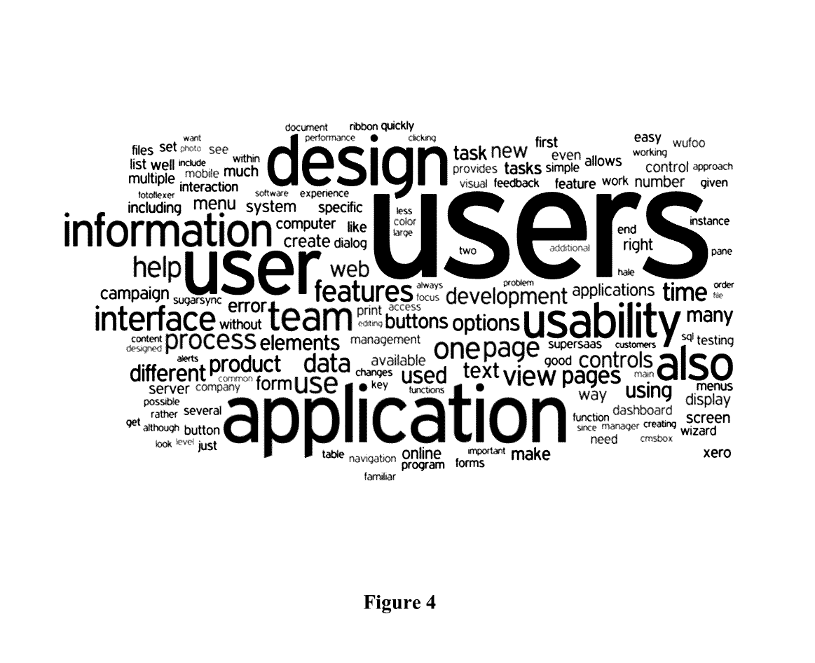

Referring now to FIG. 4, therein is shown a dynamic results page in a word cloud format. In the embodiment of FIG. 4, certain results are displayed in a larger font size to emphasize and/or give more weight to that result. For example, the word “users” has the heaviest weighting as shown by its larger size compared to any other result displayed. Similarly, “design,” “user,” and “application” have strong weights because most other words in the display are smaller in size. Words such as “files,” “set,” “see,” “mobile,” etc., are given little weight as indicated by their relative size.

Additionally, line weights and/or colors may also be used to emphasize certain results. Although not show in FIG. 4, words in bright red or dark black, for example, may have more weight than words in pink and/or green. Further, the opacity of words may also indicate a heavier or lighter weighting for certain words, wherein a more opaque word indicates a heavier weighting.

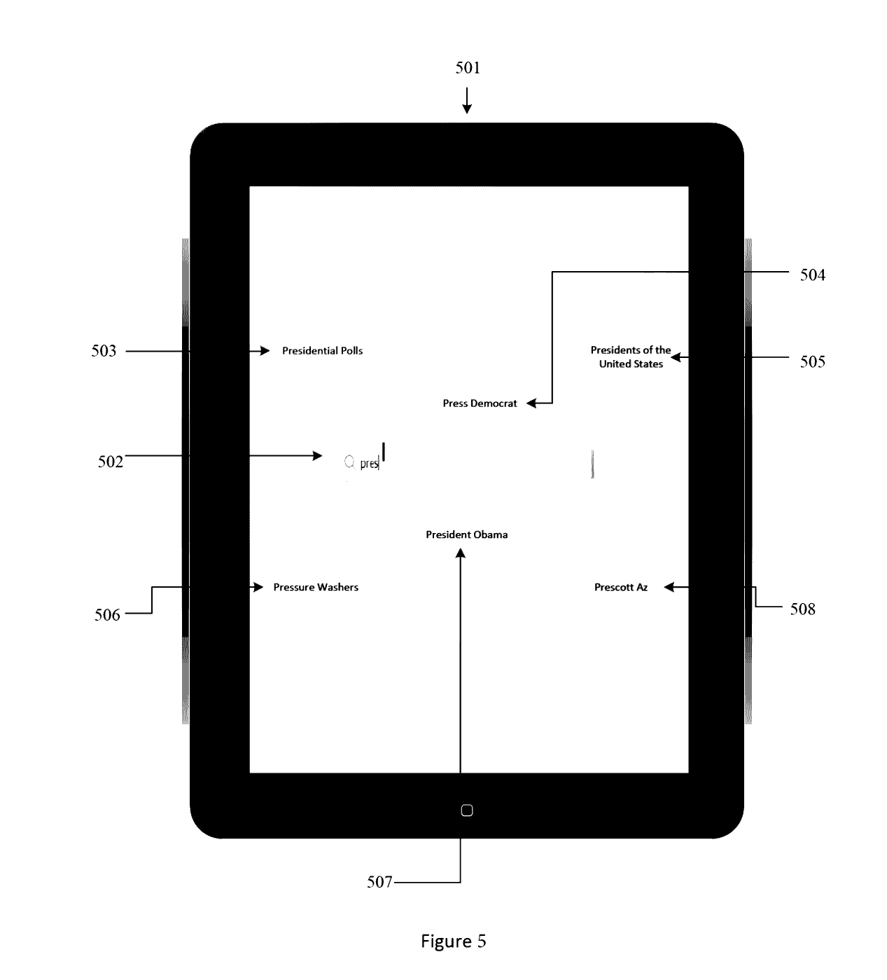

In another aspect, predictive search results and/or weighting of search results may be presented on a display device capable of, or operably connected to a second device capable of, measuring movements in space. Referring to FIG. 5, an iPad® 501 is shown (although it should be understood that this is an exemplary device, and the inventions may be implemented on other devices). The iPad is capable of detecting movement in space. Such detection may be implemented on the iPad, a laptop, a mobile phone, smartwatch, or other devices in a variety of ways, including without limitation a gyroscope, a MEMS gyroscope, an accelerometer, a camera combined with image analysis, radar, or sonar.

A user may type in a search term or partial search term 502 in a search field. Upon entry of enough of the term or terms to create a meaningful set of predictive search results, the results may be displayed in a variety of positions, some or all of them associated with a direction. For example, using the term “pres”, the terms Presidential Polls 503, Press Democrat 504, Presidents of the United States 505, Pressure Washers 506, President Obama 507, and Prescott Ariz. 508 may be displayed. These terms may optionally be displayed in association with directional arrows showing the direction that device should be tilted in order to select the terms.

It should be understood that search terms may be entered via a keyboard, a virtual keyboard, voice-to-text, or another input mechanism. In one aspect, a spoken search query may begin to generate predictive results as the user is speaking or after the user has completed speaking. A spoken interface may be particularly desirable in conjunction with predictive search and the inventions disclosed herein for narrowing or clarifying search terms, as it provides additional privacy in a public setting when compared to speaking the full search term. In addition, in conjunction with augmented reality and virtual reality, speech to text may be the preferred mechanism for initiating input.

The user then determines whether any of the predictive search terms matches her intent. If none do, additional input should be provided. If one or more does, the user tilts the device in the direction of that term. For example, if the user wanted to search for President Reagan, the user would see Presidents of the United States 505 and tilt the device to the forward right corner. In an alternative implementation, the user could simply touch the term, move a secondary device in that direction (for example, a mouse or trackpad), look in that direction in conjunction with a gaze observation device, tilt her head in that direction in the case of an immersive reality or other headset, use verbal selection, or otherwise indicate a preference to continue searching on that term.

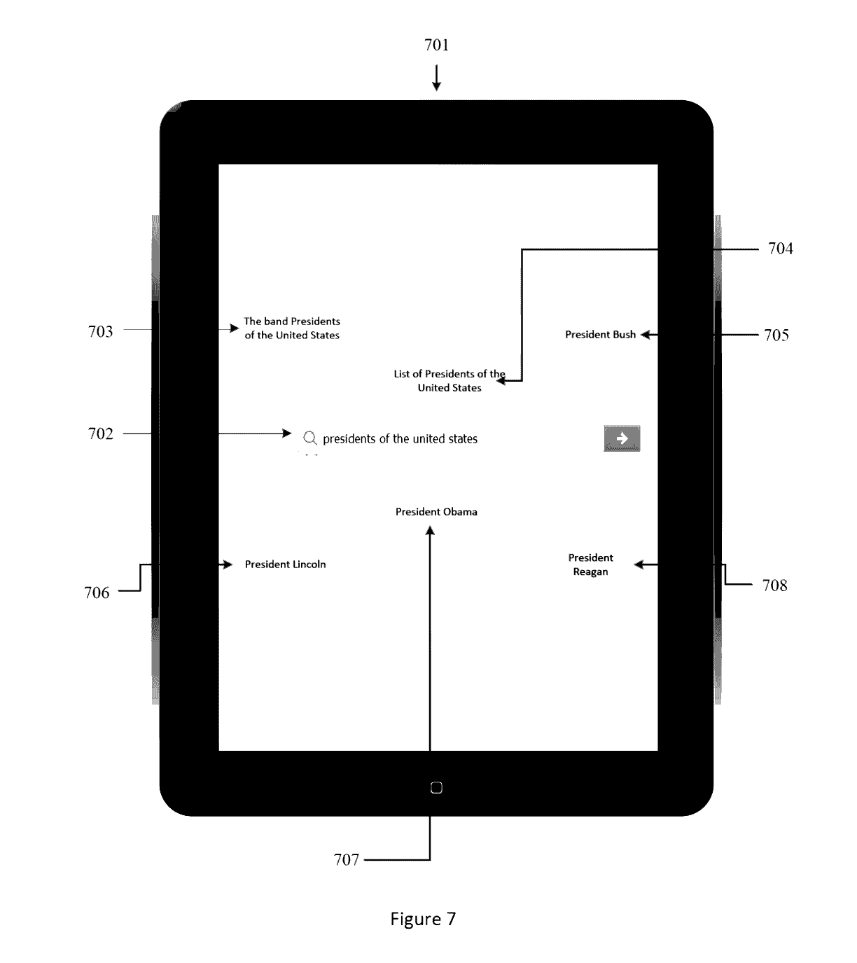

Referring now to FIG. 7, predictive results for a search for “Presidents of the United States” 702 are shown. The terms may include “the band Presidents of the United States” 703, “List of Presidents of the United States” 704, “President Bush” 705, “President Lincoln” 706, “President Obama” 707, and “President Reagan” 708. The user desiring to search for “President Reagan” would tilt the device to the bottom right or utilize an alternative implementation for selection as described above.

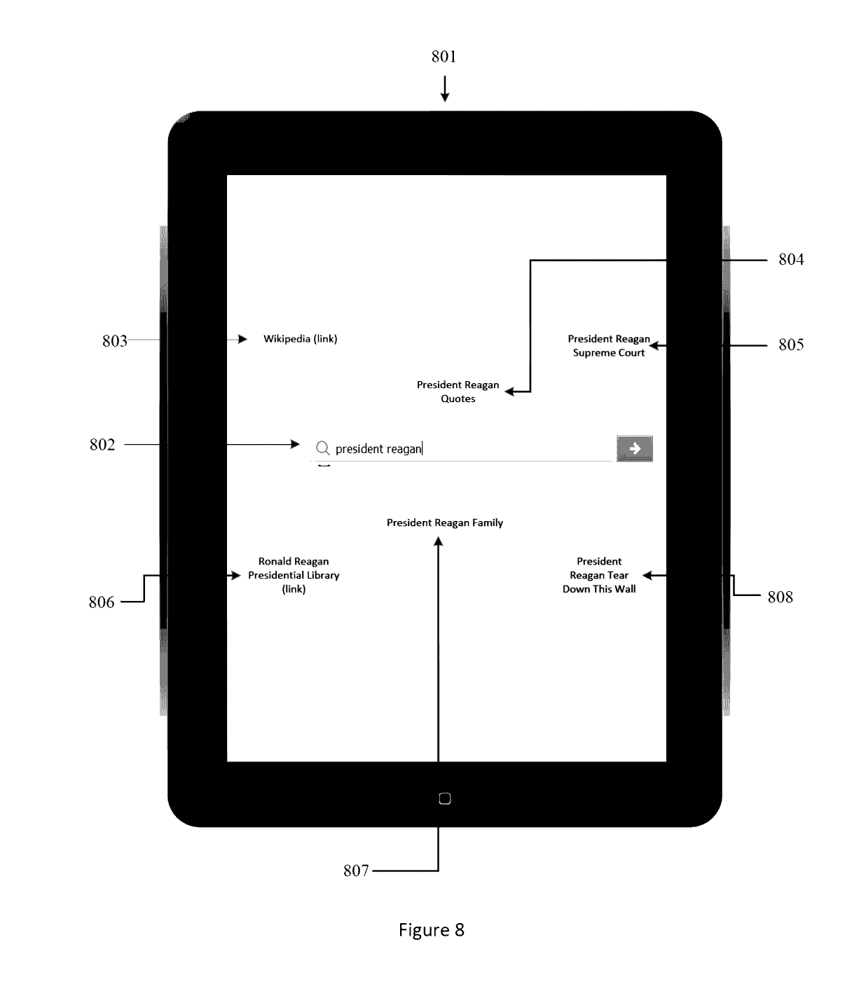

Referring now to FIG. 8, predictive results for a search for “president reagan” 802 are shown. Certain of the results may link directly to a final destination page, such as the Wikipedia page for President Reagan 803 or the office site of the Ronald Reagan Presidential Library 806. Other results may refer to additional searches, such as “President Reagan Quotes” 804, “President Reagan Supreme Court” 805, “President Reagan Tear Down This Wall” 808, or “President Reagan Family” 807. In one aspect, some or all of the suggested terms or links may be displayed along with information related to that term or link. For example, term 808 “President Reagan Tear Down This Wall” may be followed by or otherwise accompanied by “‘Tear down this wall’ is a quote from a speech made by President Reagan in West Berlin on Jun. 12, 1987, and directed to Mikhail Gorbachev.”

In one aspect, a final search or a selection of a link may be accomplished by holding the device for a period of time in the direction of the desired link. For example, a user wishing to link to Wikipedia 803 may hold the device to the top left for two seconds to select the link. The user may also, or alternatively, touch the term to select it. In one aspect, a short tilt may indicate one of either selection of an item or continued search using the item as the basis of the search, while a long tilt may indicate the other one of either selection of an item or continued search using the item as the basis of the search. The timing mechanism may be done in conjunction with an alternative implementation for selection as described above. Instead of length of time, the force of movement may also be used. For example, a forceful movement to the lower left may select “Ronald Reagan Presidential Library” 806, while a weaker movement to the lower left may indicate a continued search using that term.

In another aspect, a capacitive touch screen may be utilized such that a user may provide input through a simple touch of the screen, or multi-touch gestures of the screen, utilizing one or more fingers or a stylus configured for use with the capacitive screen. For example, a user may indicate a preference for certain search results or request a more in-depth search by pushing a finger in the direction of the preferred results on the screen, thus providing direction user input to select search results or request a further query. In some instances, the amount of force applied by the finger(s) or stylus may vary the search results selected, and or the search query transmitted.

The use of a single term for each direction in FIGS. 5, 7, and 8 is used for illustrative purposes of one implementation. Another implementation is to use one or more words or terms in a “cloud” format, such as that depicted in FIGS. 2 and 3. Taking for example FIG. 2, the entirety of FIG. 2 may be display in the upper right hand corner of a search layout similar to FIG. 8. If the user selects the upper right hand corner, the terms may then be spread out

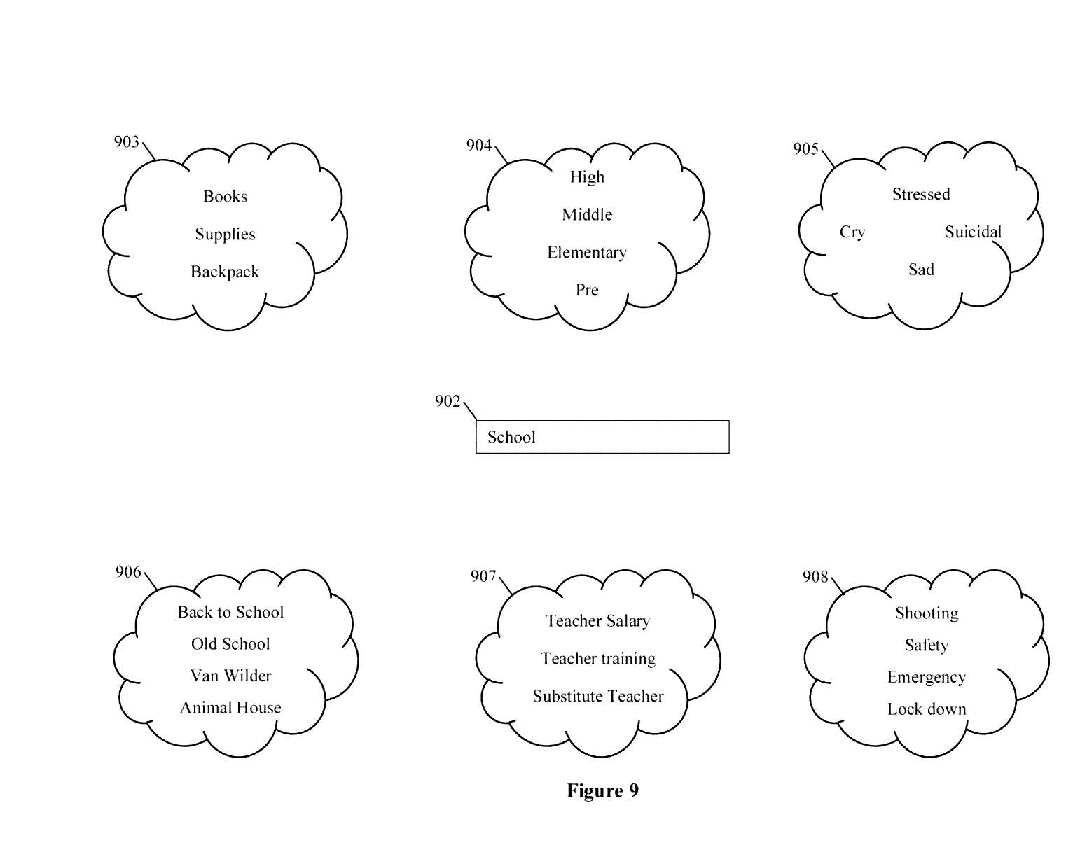

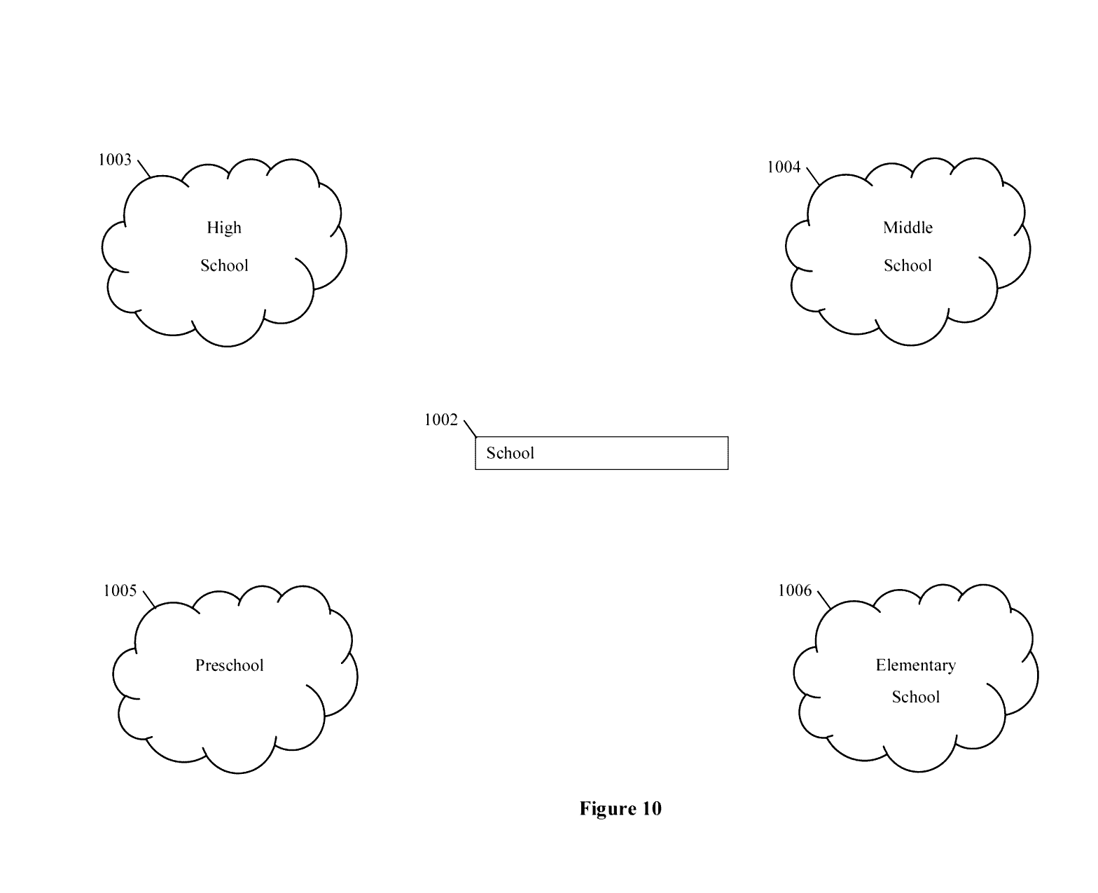

Referring now to FIG. 9, predictive results may be displayed in clusters of word clouds or word groupings. For example, the search term “school” 902 may generate six different word groupings (903, 904, 905, 906, 907, 908), one of which lists “high, middle, pre, and elementary” 904. If the user selects that grouping, such as by clicking, tilting, looking at it, or otherwise, the terms in that grouping are broken out. Referring now to FIG. 10, the search for school 1002 has now been narrowed by the earlier selection of group 904, the components of which are now displayed individually, as high school 1003, middle school 1004, preschool 1005, and elementary school 1006. It should be noted that additional clouds may be generated, such as by making 1004 “middle school, junior high school, middle school requirements, local middle schools.” In such a case, additional narrowing may be accomplished by selecting that grouping.

In each implementation, it should be understood that optional functionality may be added by allowing some or all of the search terms appearing in a cloud to be directly clickable or selectable. For example, by clicking the term “stressed” in 905, the user may then directly search “school stressed”.

In some instances, after search results are displayed, the user/searcher may resize and/or change the weighting of words within a word cloud by touching a touch pad so as to display the results in a manner more appropriate for the subsequent user. For example, using the San Francisco half marathon search referenced above, a subsequent user's intent may be determined to be the same or similar to the initial user's intent (e.g., run a half marathon in San Francisco, travel to and user certain services in San Francisco). However, the subsequent user may have a friend that lives in San Francisco, and plans to stay with the friend. Consequently, the subsequent user may want to decrease the weighting of hotels on the dynamic search page, while increasing the weighting of bars or restaurants.

In some instances, a user/searcher may connect and/or link words in the word cloud by touch on a touch pad or by mouse to create new search terms and/or results. For example, if a search cloud contains the word “hotels” and “ocean views,” a user may connect and/or link the hotels and ocean views to create results which contain hotels that advertise or include ocean views. Subsequently, the user may connect and/or link the results of hotels and ocean view with price so as to create a dynamic word cloud that includes the price of hotels with ocean views in San Francisco.

In one embodiment, an apparatus may comprise a user interface on a display device which allows the user to enter part or all of a search query, a network interface configured to transmit the search query to a server, and wherein the network interface receives predictive data from the server in response to the search query. The user interface may then display some or all of the predictive data received from the server so that at least two elements of the search data are displayed on the display device in a location associated with a direction. The user may then provide directional input through the user interface and the apparatus may correlate the directional user input to one of the at least two elements of the search, transmitting the element of the search that correlates to the to the direction to the server, and receiving new search results on the display device.

User input, including directional input may be accomplished through the use of various devices, for example, an iPad, a laptop, a mobile phone, smartwatch, immersive reality or other wearable display or headset, etc., and the directional input may be provided by the user through a touch screen, tilting or otherwise moving the display of the device, including titling of the head or the user's gaze direction (e.g., when using a immersive reality headset), movement of the watch, etc.

In another aspect the invention, an apparatus may comprise a user interface on a display device, the user interface configured to allow a user to enter part or all of a search query, a network interface configured to transmit said search query to a server and receive search data from the server in response to said search query, wherein the user interface further displays some or all of the search data received from the server as a word cloud and the user interface receives user input adding or subtracting weight from one or more elements of the word cloud; and wherein the network interface transmits the user input to the server, receives search results based on the transmitted user input, and the display device displays the search results.

In another embodiment of the invention, the apparatus may comprise a user interface on a display device, which allows a user to enter part or all of a search query, a network interface that transmits the search query to a server and receives at least two potential refinements to the search query from the server in response to the search query, and the user interface displays the at least two potential refinements, and wherein the user interface receives user input selecting one or more of the two potential refinements, for example, by moving the display device (e.g., by tilting, lateral movement or vertical movement), and transmits the selected refinement to the server. In some aspects, moving the display device comprises moving one or more body parts (e.g., a wrist, arm or head) to which the display device is attached.

In yet further aspects of the present invention, collaborative searches may be performed, wherein a person may simultaneously see what other persons are searching, what terms are being used to search, and how other persons are searching to arrive at particular results. For example, if a first person is searching for antique rocking chairs available in Los Angeles, California, and is searching “antique furniture Los Angeles Calif.,” and a second person is also searching for antique rocking chairs in Los Angeles, but is using a different search pathway (e.g., the second user is searching “antique consignment stores Los Angeles”) the relevant results of the second user's search may be displayed in the first user's search results. Such collaborative search results may be displayed in one or more dynamic result pages, and in some aspects, users may also change the weighting given to certain search results and/or select and/or alternate between different displays of collaborative results.

In some aspects, additional content and/or results of concurrent and/or subsequent user's searches may be added to the dynamic search page results so as to account for information and/or data that may have been missed by an initial or concurrent user. For example, the current weather and/or predicted weather in San Francisco on the date of the half marathon may be added. In another example, a packing list and/or a list of items not to forget (e.g., confirmation of race entry, running shoes, sun glasses, etc.) may be generated.

In some instances, a plurality of word clouds may be grouped together on one dynamic display. In such instances, users/searchers may resize clouds to change the weighting of the entire cloud with respect to other clouds within the grouping. Users/searchers may also select one or more clouds from the group of clouds, for example, by touch on a touch screen or by mouse. Such selected clouds would each be displayed on its own dynamic results page.

In some aspects, the dynamic search page may display the names of persons who conducted similar searches (with proper permissions), or may display the names of social media friends who also performed similar searches. In some aspects, search results may be automatically posted to friends on social media. In some aspects, a dynamic social media group may be formed for persons searching the same or similar aggregated searches, and in some aspects, persons may join a dynamic social media group by opting in and/or may automatically be joined if the person conducts the same and/or a similar group of searches (e.g., when N similar searches are performed).

In some embodiments of the present invention, after the intent of the searcher is determined, the searcher may be provided with a one-time-only offer that may be accepted within Y time period (e.g., 120 seconds), and may purchase goods and/or services (e.g., a hotel room, flight, event entry, etc.) at a discount where surpluses exist and/or the vendor or merchant providing such goods or services agrees to offer such discount. In some embodiments, searchers may be offered such discounts through Groupon® and/or other “deal-of-the-day” recommendation services and/or an online retailer, employment site, etc.

In some embodiments, the dynamic search page and/or the data collected from the previous searches may be utilized to generate and/or power advertising content within the dynamic search page (e.g., in conjunction with Google AdSense® and/or other advertising software and/or algorithms).

The various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For example, the various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application-Specific Integrated Circuit (ASIC). The ASIC may reside in a system element. In the alternative, the processor and the storage medium may reside as discrete components or other system element.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any non-transitory medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM, DVD, Blu-ray or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes but is not limited to compact disc (CD), laser disc, optical disc, digital versatile disc (DVD), magnetic hard disk and Blu-ray disc, wherein disks usually reproduce data magnetically, while discs reproduce data optically with lasers. Combinations of the above should also be included within the scope of computer-readable media.

Processes performed by the system nodes described herein, or portions thereof, may be coded as machine readable instructions for performance by one or more programmable computers, and recorded on a computer-readable media. The described systems and processes merely exemplify various embodiments of enhanced features. The present technology is not limited by these examples.

### Conclusion

Thus, embodiments of the present disclosure advantageously provide methods of aggregating searches, search pathways, trees and/or search components, and displaying search results in a dynamic format, which may be altered and/or controlled by the searchers. Additionally, embodiments of the present invention provide methods for coordinating searches with current events and/or news events, and performing collaborative searches in order to minimize the time taken to provide search results and maximize the accuracy and relevancy of the results.

The foregoing descriptions of specific embodiments of the present invention have been presented for purposes of illustration and description. They are not intended to be exhaustive or to limit the invention to the precise forms disclosed. Obviously, many modifications and variations are possible in light of the above teaching. The embodiments were chosen and described in order to best explain the principals of the invention and its practical application, to thereby enable others skilled in the art to best utilize the invention and the various embodiments and modifications as are suited to the particular use contemplated. It is intended that the scope of the invention be defined by the components and elements described herein and their equivalents.

What is claimed is:

1. An apparatus, comprising:
a user interface on a display device, the user interface configured to allow a user to enter part or all of a search query;
a network interface configured to transmit said search query to a server and receive predictive data from the server in response to said search query;
wherein the user interface further displays some or all of the predictive data received from the server such that at least two elements of the search data are displayed via the display device in a location associated with a direction;
wherein the user interface detects directional user input, and the apparatus correlates the directional user input to one of the at least two elements of the search, transmits the element of the search that correlates to the direction to the server and receives new search results based on the transmitted element of the predictive search; and
wherein the user interface displays the new search results on the display device.

2. The apparatus of claim 1, where the directional user input is tilting of the display device.

3. The apparatus of claim 2, where the tilting is measured at least in part by a gyroscope.

4. The apparatus of claim 2, where the tilting is measured at least in part by an accelerometer.

5. The apparatus of claim 1, where the search query transmitted to the server differs based on how long the directional user input is maintained.

6. The apparatus of claim 1, where the directional user input is movement of a finger across a touch screen.

7. The apparatus of claim 6, where the search query transmitted to the server differs based on the amount of force applied via the finger.

8. The apparatus of claim 1, where the display device is located on the user's head or face.

9. The apparatus of claim 1, where the directional user input is tilting of a user's head.

10. The apparatus of claim 1, where the directional user input is the user's gaze direction.

11. The apparatus of claim 1, where the directional user input is movement of a watch.

12. An apparatus, comprising:
a user interface on a display device, the user interface configured to allow a user to enter part or all of a search query;
a network interface configured to transmit said search query to a server and receive search data from the server in response to said search query;
wherein the user interface further displays some or all of the search data received from the server as a word cloud and the user interface receives user input adding or subtracting weight from one or more elements of the word cloud; and
wherein the network interface transmits the user input to the server, receives search results based on the transmitted user input, and the display device displays the search results.

13. The apparatus of claim 12, where the user input adding or subtracting weight comprises a pinching or stretching motion associated with at least one part of the word cloud.

14. The apparatus of claim 12, where the user input adding or subtracting weight comprises moving elements of the word cloud closer or further from a point on the display device.

15. The apparatus of claim 12, where the search results are predictive search and the word cloud is arranged, at least in part, by the subject matter associated with the predictive search results.

16. An apparatus, comprising:
a user interface on a display device, the user interface configured to allow a user to enter part or all of a search query;
a network interface configured to transmit said search query to a server and receive at least two potential refinements to the search query from the server in response to said search query;
wherein the user interface further displays the at least two potential refinements and receives user input selecting one of the at least two potential refinements;
wherein the user input is moving the display device; and
wherein the network interface transmits the selected refinement to the server.

17. The apparatus of claim 16, where the moving the display device comprises tilting.

18. The apparatus of claim 16, where the moving the display device comprises lateral motion.

19. The apparatus of claim 16, where the moving the display device comprises vertical motion.

20. The apparatus of claim 16, where the moving the display device comprises moving a body part to which the display device is attached.
